(19) United States
(12) Patent Application Publication
(10) Pub. No.: US 2026/0046832 A1
(43) Pub. Date: Feb. 12, 2026

(54) REQUEST OF AUTOMATED FREQUENCY COORDINATION RESPONSE

(71) Applicant: HEWLETT PACKARD ENTERPRISE DEVELOPMENT LP, Spring, TX (US)

(72) Inventors: Junpeng Wu, Beijing (CN); Rajini Balay, San Jose, CA (US); Subbiah Nagarajan Veerabudran, San Jose, CA (US); Nethra Muniyappa, San Jose, CA (US); Zhonglin Feng, Beijing (CN); Xiumeng Wang, Beijing (CN); Yiting Zheng, Beijing (CN)

(21) Appl. No.: 18/799,590

(22) Filed: Aug. 9, 2024

(51) Int. Cl. H04W 64/00; H04W 52/34; H04W 72/0453

(52) U.S. Cl. CPC H04W 64/003; H04W 52/346; H04W 72/0453

(57) ABSTRACT

In implementations of the present disclosure, a solution for requesting an AFC response is provided. An access point (AP) collects a first number of location samples of the AP from a positioning system and determines a location range of the AP based on the first number of the location samples and sends the location range to a server for frequency coordination. If a location of the AP is unchanged, the AP may receive at least one available channel and power from the server. If the location of the AP is changed, the AP may collect a second number of location samples of the AP from the positioning system, and update the location range of the AP based on the second number of location samples. In this way, the time for obtaining the authorized channel and power by Federal Communications Commission (FCC) can be reduced.

### BACKGROUND

In the field of Wi-Fi, a Wi-Fi standard (e.g., Institute of Electrical and Electronics Engineers (IEEE) 802.11be, also referred to as Wi-Fi 7) can provide several different radio frequency (RF) ranges (also referred to as frequency bands herein) for use in wireless communications. Examples of frequency bands may include the 2.4 gigahertz (GHz) frequency band, the 5 GHz frequency band, and the 6 GHz frequency band which opened recently.

Automated Frequency Coordination (AFC) is a system designed to coordinate the use of the radio spectrum. The system for AFC may comprise a database which records the frequency bands in use by a variety of radio frequency services within a specific geographic area. The Federal Communications Commission (FCC) in the United States has approved AFC vendors to provide AFC services to access points (APs) and other wireless communication devices which would like to operate within the 6 GHz frequency band for Wi-Fi connections.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1A illustrates an example network environment in which example implementations of the present disclosure may be implemented;

FIG. 1B illustrates an example layout in which the APs connect to a Frequency Coordination Orchestrator (FCO) directly according to implementations of the present disclosure;

FIG. 2 illustrates example specific geographic areas according to implementations of the present disclosure;

FIG. 3 illustrates an example diagram of error ellipse of Global Positioning System (GPS) coordinates according to implementations of the present disclosure;

FIG. 4 illustrates an example process of requesting an AFC response according to implementations of the present disclosure;

FIG. 5 illustrates an example diagram of relative locations associated with a moving AP, a specific geographic area, and a location threshold according to implementations of the present disclosure;

FIG. 6 illustrates an example timeline when an AP brings up according to implementations of the present disclosure;

FIG. 7 illustrates an example flow chart of an example method for requesting an AFC response according to implementations of the present disclosure; and

FIG. 8 illustrates an example AP according to implementations of the present disclosure.

### DETAILED DESCRIPTION

According to the FCC guidance relating to wireless communication protocols for the 6 GHz frequency band (may be referred to as the 6 GHz standard thereafter), if an AP wishes to operate in the 6 GHz frequency band in standard power mode (sometimes referred to as an outdoor power mode), then the AP should obtain an approval from the AFC vendor before it broadcasts over the 6 GHz frequency band. The AFC vendor may be some companies which were authorized by the FCC to provide AFC services. These AFC services are designed to facilitate the use of the 6 GHz frequency band by APs and other wireless communication devices. These AFC services can ensure that the frequency bands are used efficiently and without causing interference to other services. An AFC vendor would be responsible for managing the registered database and ensuring that the frequency bands are used in compliance with FCC regulations, thereby facilitating the deployment of new wireless services in the 6 GHz frequency band.

Traditionally, if an AP wants to obtain the AFC response from the AFC vendor, the AP may report its location in a manner of GPS data. The GPS data may be collected by a GPS receiver associated with the AP and it usually takes a lot of time to collect enough GPS data. Further, it takes a lot of time to send the AFC request to the AFC vendor, and to receive the AFC response from the queried AFC vendor. Therefore, the time cost of the above processes can be especially long for large enterprise wireless Local Area Network (WLAN) deployments with many APs operating in standard power mode over the 6 GHz frequency band.

In summary, the FCC requires APs to provide precise location coordinates to it (for example, an FCC server or an authorized AFC vendor) for authorization and to enable 6G radio operation at standard power levels. The traditional solution relies on APs reporting GPS data every fifteen minutes, and a lot of GPS samples are needed for calculating the accurate GPS coordinates. Typically, the required number of GPS samples is at least one hundred. It usually takes more than sixteen minutes by default to collect one hundred GPS samples, which means it will take quite a lot of time to obtain an authorized channel and power by FCC. Therefore, there is a need to reduce the time for obtaining the authorized channel and power by FCC.

Therefore, implementations of the present disclosure propose a solution for requesting an AFC response. Generally, an AP collects a first number of location samples of the AP from a positioning system. The AP determines a location range of the AP based on the first number of the location samples and sends the location range to a server for frequency coordination. If the AP determines that a location of the AP is unchanged based on the location range and a previous location range of the AP, it may receive at least one available channel and power from the server. If the AP determines that the location of the AP is changed based on the location range and the previous location range of the AP, the AP may collect a second number of location samples of the AP from the positioning system, and the AP may update the location range of the AP based on the second number of location samples.

According to implementations of the present disclosure, the time for obtaining the authorized channel and power by FCC (in the name of AFC vendor) can be reduced, and it can enable APs to broadcast over the 6 GHz frequency band in the standard power mode more quickly.

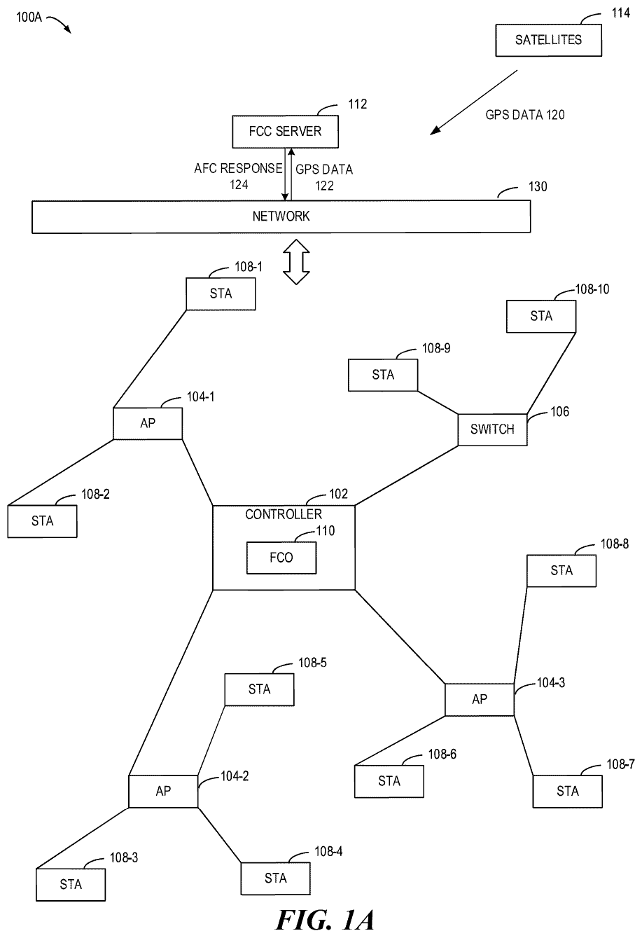

The advantages of implementations of the present disclosure will be described with reference to example implementations as described below. Reference is made below to FIG. 1A through FIG. 8 to illustrate basic principles and several example implementations of the present disclosure herein.

Reference is made to FIG. 1A, which illustrates an example network environment 100A in which example implementations of the present disclosure may be implemented. Before describing example implementations of the present disclosure in detail, it may be useful to describe an example network environment within which examples may be implemented. As shown in FIG. 1A, the network environment 100A may be implemented for an organization, such as an enterprise, a school, a medical center, a healthcare facility, or other organizations. The network environment 100A may be implemented for movable gathering activities, such as an outdoor concert, an outdoor wedding, an outdoor speech, a temporary gathering, and the like.

This network environment 100A may illustrate an example of a configuration implemented with an organization having a lot of stations (STAs) 108-1, 108-2, . . . , and 108-10 (may be collectively or individually referred to as STA(s) 108 thereafter). Some example of the STAs may be user devices such as laptops, personal computers, tablets, smartphones, smart watches, smart glasses, and so on. The STAs 108 may also be called client devices.

In some example implementations, the example of the STAs 108 may also include servers, web servers, authentication servers, authentication-authorization-accounting (AAA) servers, Dynamic Host Configuration Protocol (DHCP) servers, Domain Name System (DNS) servers, Internet Protocol (IP) servers, Virtual Private Network (VPN) servers, network policy servers, mainframes, e-readers, netbook computers, televisions and similar monitors, smart TVs, content receivers, set-top boxes, personal digital assistants (PDAs), smart terminals, dumb terminals, virtual terminals, game consoles, virtual assistants, Internet of Things (IOT) devices, and the like.

The network environment 100A may further comprise a lot of APs 104-1, 104-2, and 104-3 (may be collectively or individually referred to as AP(s) 104 thereafter). The APs 104 may perform networking operations such as providing network access, performing authentication, routing network traffic to provide wireless connectivity, and so on. The APs 104 and STAs 108 together may be examples of wireless communication devices which exchange wireless communication signals over a network operating on the 2.4 GHz frequency band, the 5 GHz frequency band, and/or the 6 GHz frequency band.

In some example implementations, the network environment 100A may comprise a switch 106. The switch 106 may also perform the similar functionality to the APs 104. Other network devices may be routers or gateways which may provide the similar functionality to the APs 104 or the switch 106. For the purpose of simplification, they are not shown in FIG. 1A. The APs 104 and the switch 106 are collectively referred to as network devices. The APs 104 may control network access of the STAs 108 and may authenticate the STAs 108 for connecting to the APs 104 and through the APs 104, to other devices within the network environment 100A.

The network environment 100A may further comprise a controller 102. The controller 102 may manage the network devices (such as the APs 104 and the switch 106). The controller 102 may be a server or a cloud service. The controller 102 may be located in the same or a different physical or geographical location from the STAs 108 or APs 104, as well as the switch 106. In some example implementations, the controller 102 may be an AP or may provide the functionality of an AP.

In some example implementations, an FCO 110 may be included in the controller 102. Examples of the FCO may be hardware, software, and/or firmware, or their combinations. In some example implementations, the FCO may be individual to the controller 102 and may be an individual cloud service. This means the FCO 110 can be physically outside the controller 102. The FCO 110 may provide centralized management and coordination of frequency usage. The FCO 110 may be designed to work with GPS-enabled, standard power APs. When an AP boots up for the first time, the AP may send its geo-location and other AFC-required information to the AFC vendor through the FCO service. The AP may then receive available channel and power information as part of the AFC response. The AP may enable the 6 GHz radio after it receives the AFC response. This end-to-end process may take a lot of time, for example, around 20 minutes.

As shown in FIG. 1A, the controller 102 may be in communication with the APs 104 and/or the switch 106. The APs 104 and/or the switch 106 may provide network connectivity to various STAs 108. With the connection to the APs 104 or switch 106, the STAs 108 may access network resources over the network 130.

In some example implementations, the network 130 may be a public or private network, such as the Internet, or other communication network. The network 130 may include third-party telecommunication lines, such as phone lines, broadcast coaxial cable, fiber optic cables, cellular communications, satellite communications, and the like. The network 130 may include any number of intermediate network devices, such as switches, routers, gateways, servers, and/or controllers, which are not directly part of the network environment 100A but that facilitate communication between the various parts of the network environment 100A, and between the network environment 100A and other network-connected entities. The network 130 may include various content servers. The content servers may comprise various providers of multimedia downloadable and streaming content, such as audio, video, graphical, and/or text content, or any combination thereof. Examples of content servers may include, for example, web servers, streaming radio and video providers, and cable/satellite television providers. The STAs 108 may request and access the multimedia content provided by the content servers.

It is to be understood that the layout shown in FIG. 1A is only an example for illustrative purposes without limitations. For example, the STA 108-1 and the STA 108-2 may be connected with the AP 104-1. The STA 108-3, The STA 108-4, and the STA 108-5 may be connected with the AP 104-2. The STA 108-6, The STA 108-7 and the STA 108-8 may be connected with the AP 104-3. The STA 108-9 and the STA 108-10 may be connected with the switch 106. The AP 104-1, AP 104-2, AP 104-3, and the switch 106 may be connected with the controller 102.

Now description will proceed by taking the AP 104-1 and the STA 108-1 as an example scenario of requesting an AFC response. When the AP 104-1 first brings up, the AP 104-1 may not be generally permitted to broadcast over the 6 GHz frequency band in the standard power mode until the AP 104-1 receives an AFC response indicating allowable channels and maximum allowable power level. To obtain the AFC response, the AP 104-1 may receive GPS data 120 from a plurality of satellites 114.

The AP 104-1 may use the information of the GPS data 120 to determine some GPS coordinates representing the latitude, the longitude, and the altitude of the AP 104-1. The GPS coordinate may also be referred to as the GPS sample thereafter and they will be used interchangeably. Upon the AP 104-1 collects enough numbers (for example, 30, 60, 90, or 100) of GPS samples, it will report the information of GPS samples to the FCO 110. The information of GPS samples may also be referred to as the GPS data 122 and they will be used interchangeably.

The FCO 110 may receive the GPS data 122 from the AP 104-1. At this moment, the GPS data 122 may be a coarse GPS data 122 which is determined based on 30 GPS samples. The FCO 110 may determine that if the AP 104-1 has reported the GPS data 122 recently before this moment. If the FCO 110 has not received GPS data 122 before or does not save any GPS data 122 of the AP 104-1, it will wait for the complete GPS data 122 which is determined based on 100 GPS samples.

If the FCO 110 has received the GPS data 122 from the AP 104-1 recently, then the FCO 110 may determine if the location of the AP 104-1 has moved. If the location of the AP 104-1 has moved a lot (for example, the distance which the AP 104-1 has moved is greater than a distance threshold), then the FCO 110 may wait for more GPS data 122 which is determined based on more GPS samples (for example, 60, 90 or 100). If the FCO 110 determines the location of the AP 104-1 has not moved (for example, the distance which the AP 104-1 has moved is less than the distance threshold), the FCO 110 may use its previously saved GPS data 122 to request an AFC response 124 from the FCC server 112. The FCC server 112 may be an example of the AFC vendor as discussed above.

Reference is made to FIG. 1B, which illustrates an example layout 100B in which the APs connect to the FCO directly according to implementations of the present disclosure. The layout 100B comprises the cloud APs 104-4, 104-5, and 104-6. The cloud APs 104-4, 104-5 and 104-6 can communicate with cloud FCO service 130 directly. Therefore, there is no controller in layout 100B. The cloud APs 104-4, 104-5, and 104-6 may send GPS data directly to the cloud FCO server 130 and receive the AFC response from the cloud FCO server 130 directly.

It is to be noted that a cloud AP may refer to a type of AP that delegate some functions that require high timeliness, such as fast roaming capabilities, to the local AP itself, while most other functions with less stringent timeliness requirements are managed through the cloud platform, such as monitoring and tuning, thereby enhancing the operational efficiency and security stability of the network. Could APs are also applicable for the proposed solution.

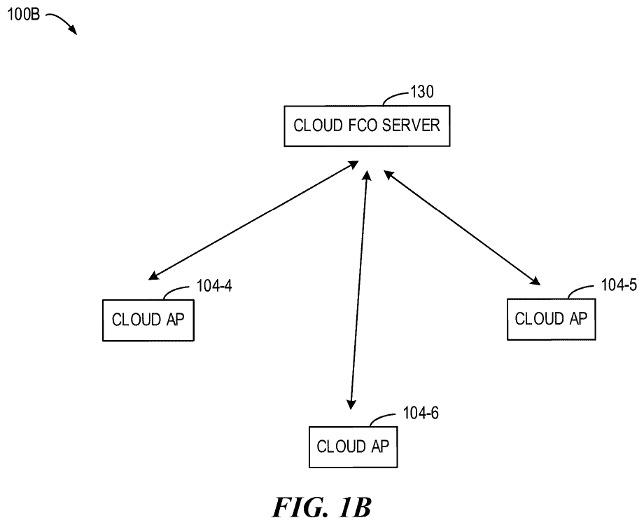

Reference is made to FIG. 2, which illustrates example specific geographic areas 200 according to implementations of the present disclosure. As shown in FIG. 2, a network device 202 may be an incumbent for a specific geographical region 206. That is, the communications via any other devices may not affect the performance of the network device 202. The AFC vendor may determine the available channels and power levels in the specific geographical region 206. Similarly, the AFC vendor may determine a specific geographical region 208 based on the network device 204. Within the specific geographical region 208, the communications via any other devices may not affect the performance of the network device 204.

An AP 210 may be located between the network device 202 and the network device 204. The distance between the specific geographical region 206 and the AP 210 may a distance 220. The distance between the specific geographical region 208 and the AP 210 may a distance 222. It is to be appreciated that although the ends of the distance 220 or the distance 222 are at the edges of the elements, respectively, the distance 220 or the distance 222 can count from the centers of the elements, respectively.

It is to be appreciated that the areas of the specific geographical region 206 and the specific geographical region 208 are only examples. The AP 210 is shown outside the specific geographical region 206 and the specific geographical region 208 may be physically outside them, but the channels and the power levels which the AP 210 is using may still affect the performance of the network device 202 and the network device 204.

Therefore, if the AP 210 wishes to operate on the 6 GHz frequency band, the AP 210 may report its location information (for example, in the manner of the GPS data) to the AFC vendor. Once the AFC vendor receives the location information of the AP 210, it may determine the available channels and the power levels for use by the AP 210. For example, the AFC vendor may determine the distance 220 and the distance 222 based on the received location information by computing the GPS coordinates of the AP 210 and the centers of the specific geographical region 206 and the specific geographical region 208, respectively. The AFC vendor may further consider the transmission directions of the network device 202 and the network device 204 as well as other information which is needed. Based on the above information, the AFC vendor may assign available channels and power levels to the AP 210. For example, the AFC vendor may assign channel 1 and channel 37 to the AP 210 with both power levels of −20 dBm via the AFC response.

Generally, an AFC response may indicate channels which the querying AP is allowed to broadcast 6 GHz communications over in the standard power mode, and the AFC response may indicate a maximum allowable power level which the querying AP is allowed to use when broadcasting over the 6 GHz communications in the standard power mode.

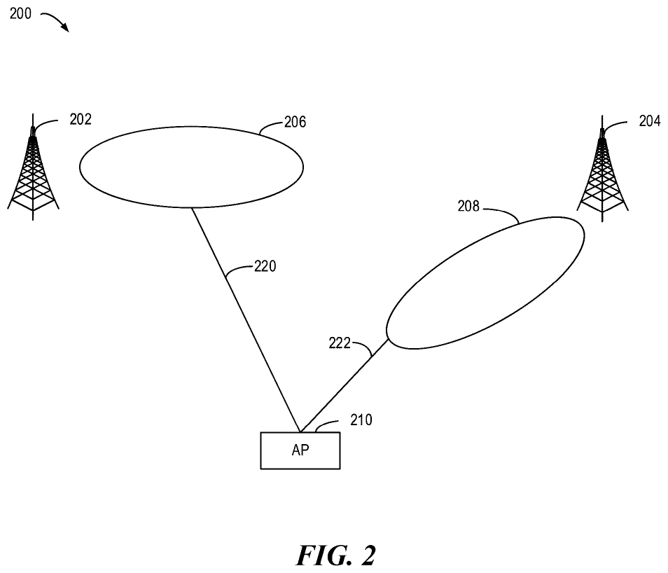

Reference is made to FIG. 3, which illustrates an example diagram 300 of error ellipse of Global Positioning System (GPS) coordinates according to implementations of the present disclosure. As shown in FIG. 3, an AP 302 may be deployed a GPS module 304 to receive GPS data 320 from a plurality of GPS satellites 306. Usually, the number of the plurality of GPS satellites 306 is greater than four. The basic principle of GPS positioning involves using at least four GPS satellites to determine the location of the receiver on the ground by measuring the distance from each satellite to the GPS receiver.

As an example, the plurality of GPS satellites 306 may continuously send signals to Earth containing their precise location and time stamps. The GPS module 304 may receive GPS signals containing the precise location and time stamps of the plurality of GPS satellites 306. The GPS module 304 may the GPS signals and record the time it takes for the signals to travel. The GPS module 304 may calculate the pseudorange (a distance between a GPS receiver and a satellite) to each satellite (the actual distance plus the receiver clock error) of the plurality of GPS satellites 306. The timestamp in the GPS signals may allow the GPS module 304 to calculate the time at which the GPS signal traveled and thus the distances between the GPS module 304 and each of the plurality of GPS satellites 306 can be determined. Since there are four unknowns (the X, Y, and Z position coordinates of the AP 302 and the receiver clock errors), at least four GPS satellites are needed to set up the equations and solve for these four unknowns. The GPS module 304 may use the pseudorange information received from the plurality of GPS satellites 306 to calculate its precise position on the Earth through the triangulation approach. The GPS signals experience a delay as they pass through the atmosphere, and the GPS module 304 may need to correct this delay to improve the positioning accuracy.

The GPS module 304 of the AP 302 may receive a lot of GPS signals and may calculate a lot of GPS coordinates during a period of time. The GPS coordinates may be referred to as GPS samples thereafter. In some example implementations, the pseudorange and carrier phase information of the GPS signals received from the plurality of GPS satellites 306 (as well as other associated data such as timestamps and satellite visibility information) may also be called the GPS sample.

According to AFC regulations, an AP should report its GPS data with an error ellipse. The error ellipse used herein may also be referred to as a GPS ellipse or a coordinate ellipse, and those terms may be used interchangeably. The error ellipse may describe the accuracy of GPS positioning. It may be a metric used to indicate the accuracy of the GPS receiver at a specific time and place. The error ellipse usually has three main axes. One axis may be the horizontal error ellipse which indicates the accuracy in the east-west direction. The other axis may be the vertical error ellipse which indicates the accuracy in the north-south direction. A further axis may be an axis in the tangent direction to the ground.

Generally, the error ellipse may be a graphical representation of the uncertainty of the coordinate estimates of each observation point obtained after adjusting the observation data in GPS data processing. The error ellipse may provide a visual method to evaluate the positioning accuracy. It may show the distribution of uncertainty of the estimated point on the horizontal plane. The error ellipse may represent a confidence interval, such as a 95% confidence level, which means that there is a 95% probability that the true position is within this error ellipse. Usually, the error ellipse may be in three-dimensional (3-D). However, for illustrative purposes, in FIG. 3, an error ellipse 310 is shown in two dimensional (2-D), and the Z direction is not shown.

As shown by the error ellipse 310, a hollow circle represents a GPS sample. To meet the requirement of FCC, the hollow circles outside the error ellipse 310 should be less than 5% of the total GPS samples. That is, the hollow circles inside the error ellipse 310 should be more than 95% of the total GPS samples. The reported location which meets the above condition can be considered an accurate location.

The GPS module 304 of the AP 302 may determine the error ellipse 310 based on a plurality of GPS samples, for example, one hundred GPS samples. This is because of the FCC requirements for AFC in the 6 GHz frequency band. FCC may require several steps to ensure that an AP can operate with the standard power without causing harmful interference. In general, the required steps by FCC may require an AP to provide its location coordinates to the FCC server accurately to be authorized for the 6 GHz standard power mode. The AP must collect GPS samples to compute stable and accurate GPS coordinates. For example, an evaluation indicates that at least one hundred GPS samples are needed for a sufficiently accurate coordinate ellipse. Therefore, the AP must wait until it collects at least one hundred GPS samples.

As an example, if the AP 302 collects one GPS sample every 10 seconds. This interval is chosen to ensure that each sample is independent and contributes to the accuracy of the location determination. That means that the AP 302 may spend more than sixteen minutes to collect the one hundred GPS samples. In view of the above, it can be known that it at least takes sixteen minutes to report the location of the AP 302 to the FCC server (via an FCO) since the AP 302 was brought up.

However, things may be even worse. Regularly, the AP 302 may be configured to report its location every fifteen minutes. If the AP 302 spends sixteen minutes to collect the one hundred GPS samples, it will obviously miss the first opportunity at the first fifteen minutes to report its location. Thus, the AP 302 will wait until the second opportunity to report its location, and the second opportunity is at the thirty minutes since the AP 302 brings up.

After the first report, the AP 302 may then send GPS reports at a fifteen-minute interval. This periodic reporting can help maintain the accuracy of the location of AP 302 as it may change over time. Once the FCO receives the AFC response from the FCC server or AFC vendor, the FCO may send the AFC response to the AP 302. The AP 302 may then activate its 6 GHz frequency band with the standard power on the allowed channel(s) and power level(s), because now it has been granted the appropriate channels and power levels to avoid interference.

This process highlights the importance of accurate location data for AFC in the 6 GHz frequency band. The initial delay in reporting, though it may seem lengthy, is crucial for ensuring that the FCC's requirements for location accuracy are met before the AP is authorized to operate in standard power. This periodic reporting helps maintain compliance and allows for dynamic frequency coordination as needed.

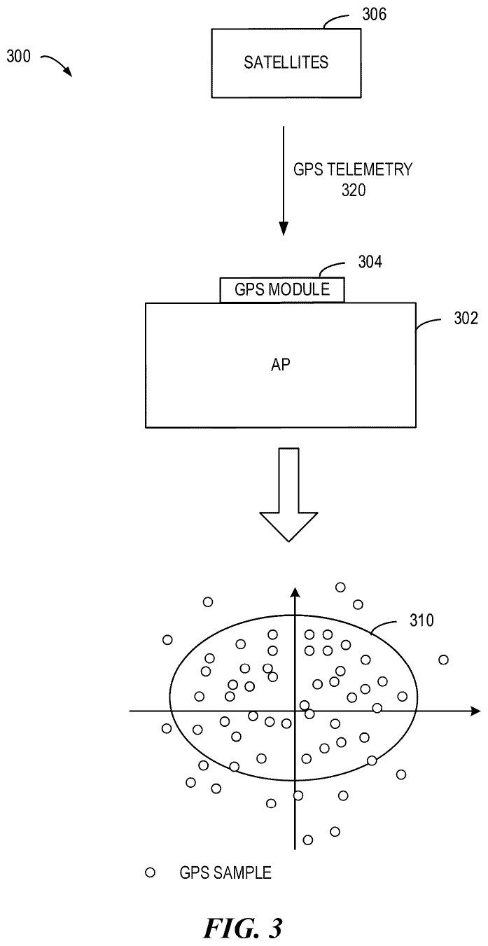

Reference is made to FIG. 4, which illustrates an example process 400 of requesting an AFC response according to implementations of the present disclosure. At block 402, an AP may bring up. For example, a user may power up, turn on, or boot up the AP. At block 404, the AP may send the first GPS data when it collects the minimum number of the GPS sample. For example, the minimum number of the GPS sample may be thirty with respect to one hundred of the GPS samples as the maximum number.

At block 406, the AP may check if it receives an AFC response or not. If the AP receives the AFC response, the process 400 may proceed to block 420. If the AP does not receive the AFC response, the process 400 may proceed to block 408. At 408, the AP may send the GPS samples every minimum number. For example, the AP may continue collecting GPS samples until it collects sixty GPS samples (twice the minimum number of the GPS samples). Upon collecting sixty GPS samples, the AP may send the sixty GPS samples to the FCC server.

In some example implementations, after the AP sent the sixty GPS samples to the FCC server, the AP may still not receive the AFC response, then the AP may continue collecting GPS samples until it collects ninety GPS samples (as three times as the minimum number of the GPS sample). Upon collecting ninety GPS samples, the AP may send the ninety GPS samples to the FCC server. This similar iterative process may continue in a similar manner as described above.

At block 410, the AP may determine if the collected GPS samples reach the maximum number of GPS samples. If the AP determines that the collected GPS samples do not reach the maximum number of GPS samples, the process 400 may proceed to block 412. If the AP determines that the collected GPS samples reach the maximum number of GPS samples, the process 400 may proceed to block 414.

At block 412, the AP may continue collecting GPS samples and return to block 410 to check if the AP collects the maximum number of GPS samples of GPS samples. At block 414, the AP has collected the maximum number of GPS samples of GPS samples and the AP may send the GPS data including the maximum number of GPS samples of GPS samples to the FCC server.

At this time, because the number of GPS samples reaches the maximum number and satisfies the FCC requirements, so the AP is likely to receive the AFC response with the available channels and power levels which are granted by the FCC server. At block 416, the AP may determine whether it receives the AFC response. If the AP receives the AFC response, it may proceed to block 420. The AP may use available channels and power levels included in the AFC response to activate communication over the 6 GHz frequency band. If the AP does not receive the AFC response, it may proceed to block 424. At block 424, the AP may retry for each maximum number of GPS samples.

Then after the AP receives the AFC response, the process 400 may proceed to block 420. At block 420, the AP may report its locations periodically. For example, every six hours. At block 422, the AP may check if the AFC response expires. If the AP determines that the AFC response does not expire, the process 400 may return to block 420. If the AP determines that the AFC response expires, the process 400 may return to block 404. In some example implementations, if the AP determines that the AFC response expires, the process 400 may return to block 414.

In this way, a smaller number of GPS samples than usual can be collected by an AP to determine a coarse GPS ellipse. The coarse error ellipse can be sent to the FCC server to request an AFC response. If the AP does not receive the AFC response, it will collect more GPS samples to determine a finer error ellipse. The AP can use the finer GPS ellipse to request the authorized channel and power from FCC sever. In this way, the time for obtaining the authorized channel and power by FCC can be reduced.

In some example implementations, the AP may first send the GPS data to the FCO and the FCO may send the GPS data to the FCC server. In some example implementations, the FCO may decide if the location of the AP is unchanged, if the FCO decides that the location of the AP is unchanged, it will use the GPS data including the minimum number of the GPS samples to request the AFC response from the FCC server. That is, the coarse GPS ellipse will be used to request the authorized channel and power from FCC.

In some example implementations, if the FCO decides that the location of the AP is changed, the AP will collect more GPS samples (for example, one hundred GPS samples as usual) to determine a normal GPS ellipse, and the AP will send the normal GPS ellipse to the FCO. The FCO may use the normal GPS ellipse to request the authorized channel and power from the FCC server. It is to be appreciated that the above functions or steps can be configured as a whole and can be implemented by one or more modules of the AP.

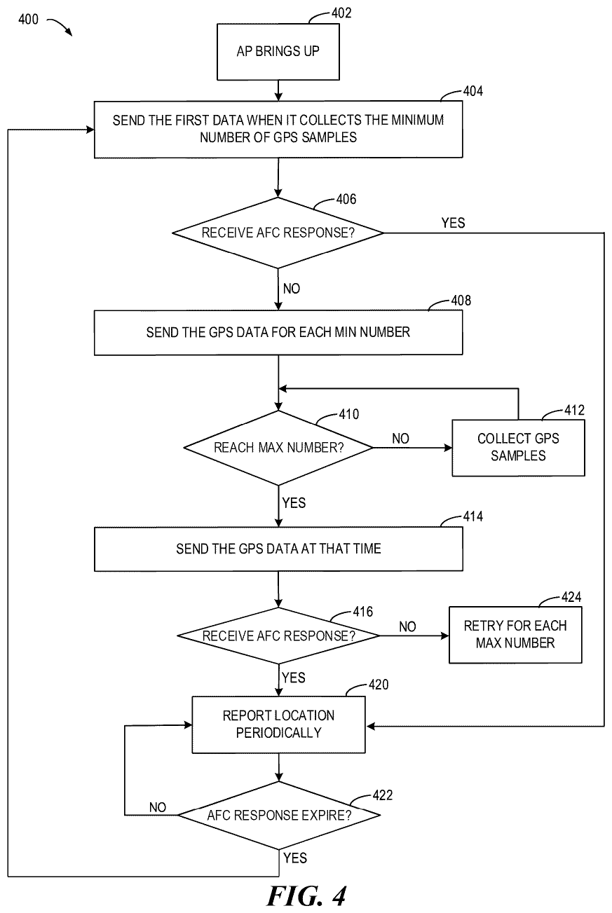

Reference is made to FIG. 5, which illustrates an example diagram 500 of relative locations associated with a moving AP, a specific geographic area, and a location threshold according to implementations of the present disclosure. FIG. 5 shows a scenario of an AP which moves to different locations with respect to a network device 502. The network device 502 is an incumbent for a specific geographical region 510.

At first, the AP 504 may be located within the specific geographical region 510 as shown. The AP 504 has been approved to use some available channels and powers over the 6 GHz frequency band. The AP 504 may move a little distance and maybe then located at a position 506. The position 506, for example, outside the specific geographical region 510 and inside a circle 512. The circle 512 may represent an area within which the AP 504 can be considered not move, and without which the AP 504 can be considered moved. This is, if the AP 504 moves to the position 506, the location of the AP 504 is considered as unchanged. The area of the circle 512 may be determined based on a location threshold. The location threshold may be a radius of the circle 512.

In some example implementations, if the location of the AP 504 is unchanged, the number of the GPS samples used to request the AFC response can be reduced. For example, the AP 504 may use its last reported locations to request the AFC response. Alternatively, the AP 504 may collect a reduced number of GPS samples (for example, thirty GPS samples) to request the AFC response. In this way, the time for obtaining the authorized channel and power by FCC can be saved.

In some example implementations, the location of the AP 504 may move to a position 508, because the position 508 is outside the circle 512, so the location of the AP 504 cannot be considered unchanged. Thus, the AP 504 may not use its last reported locations to request the AFC response. Instead, the AP 504 may collect more numbers (for example, sixty GPS samples) or a whole number of GPS samples (for example, one hundred GPS samples) to request the AFC response.

In some example implementations, how many GPS samples are to be used to request the AFC response may depend on how long the distance which the AP 504 moved. For example, if the AP 504 moved a first distance, the AP 504 may use thirty GPS samples. If the AP 504 moved a second distance longer than the first distance, the AP 504 may use sixty GPS samples. It is to be appreciated that the number and the distance are only examples without limitations. Other factors, for example, orientations or directions of transmission signals of the network device 502 can also be considered to determine if the locations of the AP 504 have changed or not.

By implementing the example implementations of FIG. 5, the time for obtaining the AFC response may depend on how long the AP moves, and thereby it provides a more flexible mechanism to request the AFC response. The time for obtaining the AFC response can be further decreased. Moreover, because the GPS samples can be reduced, the resources such as bandwidths and throughputs of the AP and the cloud services (for example, the FCO) can be saved.

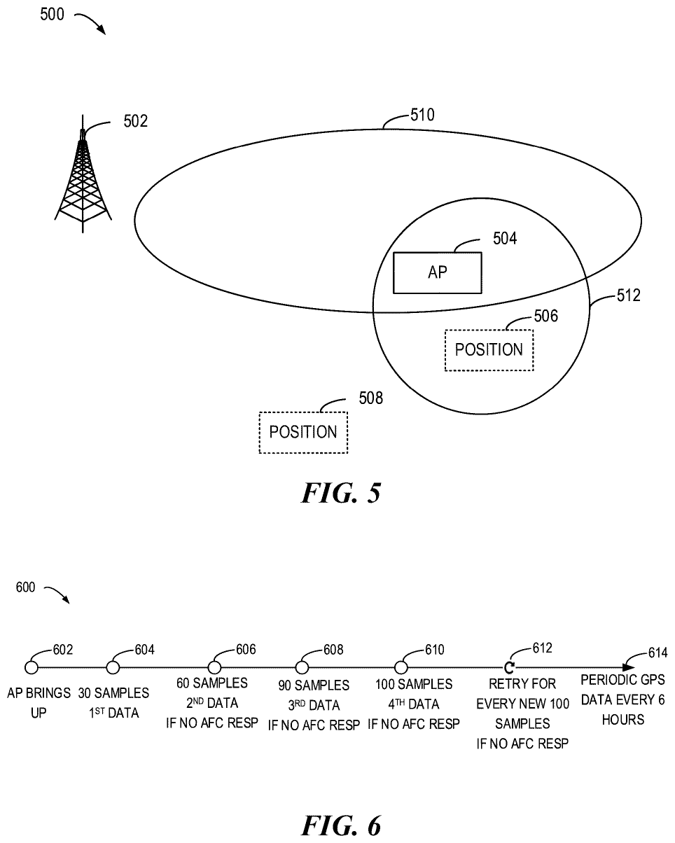

Reference is made to FIG. 6, which illustrates an example timeline 600 when an AP brings up according to implementations of the present disclosure. In general, an AP may compute the error ellipse much earlier than collecting enough GPS samples (one hundred GPS samples herein). The AP may compute the error ellipse at the first thirty GPS samples. The data amount at this time is not accurate enough, but it can allow the FCO (or sometimes may be called FCO service) to decide if the AP location is changed or not. Thus, it takes only five minutes, compared to the conventional sixteen minutes with fully accurate GPS samples.

In some example implementations, the FCO service may decide if the AP has reported GPS data recently before its boot-up. If the FCO service doesn't have GPS data for this AP, it may wait for the accurate GPS report computed with enough samples. If FCO service has the previous stored GPS data of this AP (maybe not long ago, depending on a time threshold), it may decide if the GPS coordinates of the first GPS report are in the range of the previous stored error ellipse. It means that if the bias of new GPS data is small, the FCO service may use this GPS data to request the permissible channels and powers from FCC server, thereby saving time for obtaining the AFC response.

As shown in FIG. 6, at time 602, when an AP just boots up, the AP may send the error ellipse data at a high frequency. To assure the amount of GPS samples is enough, a GPS sample counter may be used to trigger the GPS report other than the static time interval. In some example implementations, some new configurable parameters can be set to make a strategy for GPS data reports. For example, a minimum number of GPS samples (30 by default), a maximum number of GPS samples (100 by default), retry times if an AP does not receive an AFC response, and a GPS sample collecting rate (per 10 seconds by default).

At time 604, the AP may send the first GPS data when it collects a minimum number of GPS samples. If the AP doesn't receive any AFC response, the AP may send the GPS data for each minimum number (30 by default) of samples collected. For example, at time 606, the AP may send the GPS data of sixty GPS samples which is twice the minimum number. As another example, at time 608, the AP may send the GPS data of ninety GPS samples which is three times the minimum number. In some example implementations, the AP may increase the sending frequency dynamically and ensure the FCO service can obtain the first GPS data quickly. For example, it may report the GPS data every half of the minimum number.

At time 610, when the total number of collected GPS samples reaches the maximum number (100 by default), the AP may send the GPS data to the FCO service at this moment. After that, if the AP still does not receive the AFC response, the AP may retry every maximum number of the GPS samples until it receives the AFC response. At time 612, If retry times are enabled, the AP may send the GPS data for each maximum number of GPS samples collected later. In this way, it can decrease the sending frequency. At time 614, after the AP receives the valid AFC response, the AP may start to send the GPS data every six hours. When the AFC response expires and the AP doesn't receive a new AFC response, it may continue to the first step and start over again.

With the above process as described with reference to FIG. 1A to FIG. 6, the AP can bring up the 6G frequency band quickly when the AP upgrades, reboots or the AFC response expires. The AP can send the minimum GPS data traffic to obtain the AFC response, and the proposed solution also can be applicable for the scenario that a new AP is deployed. The proposed solution can reduce the huge amount of GPS report traffic between the AP and the FCO service. It can also save the resources of AP and FCO service for processing GPS data.

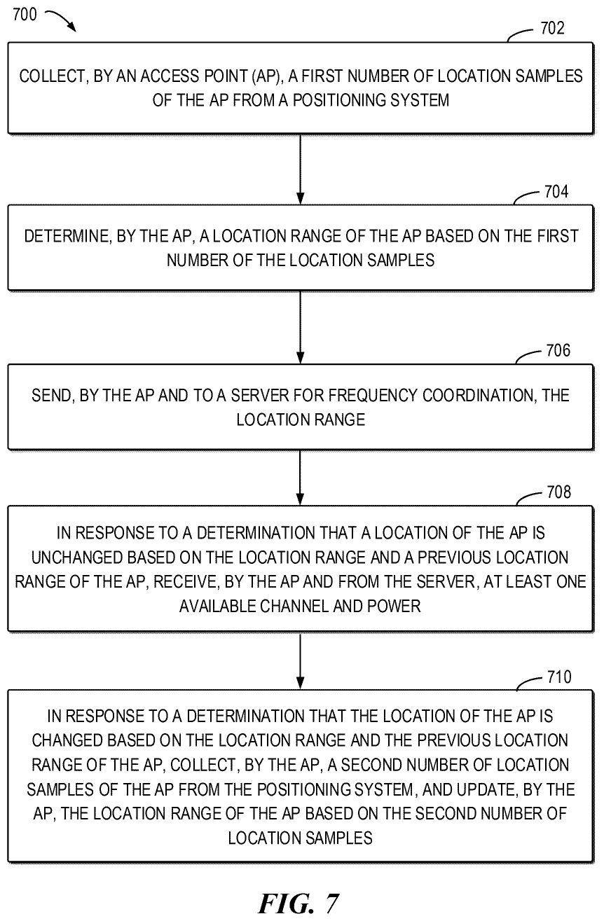

Reference is made to FIG. 7, which illustrates an example flow chart of an example method 700 for requesting an AFC response according to implementations of the present disclosure, and the method 700 may be performed by an AP.

At 702, an AP collects a first number of location samples of the AP from a positioning system. As an example, the AP may collect thirty GPS coordinates from the plurality of satellites. At 704, the AP determines a location range of the AP based on the first number of the location samples. For example, the AP may determine an error ellipse based on the collected thirty GPS samples.

At 706, the AP sends the location range to a server for frequency coordination. For example, the AP may send (via an FCO) the error ellipse to the FCC server. At 708, if the AP determines that a location of the AP is unchanged based on the location range and a previous location range of the AP, the AP receives at least one available channel and power from the server. For example, the FCO may store an error ellipse received from the AP one hour ago, then the FCO may decide the AP may not move or move a little within a location threshold based on the previously stored error ellipse and the last received error ellipse. The FCO may use this previously stored error ellipse to request an AFC response from the FCC server. The FCC server may approve the available channels and powers based on the previously stored error ellipse and may send the available channels and powers to the FCO. Then the AP may receive (via the FCO) some allowable channels and powers from the FCC server.

At 710, if the AP determines that the location of the AP is changed based on the location range and the previous location range of the AP, then the AP collects a second number of location samples of the AP from the positioning system, and the AP updates the location range of the AP based on the second number of location samples. For example, the FCO may store an error ellipse received from the AP one day ago, then the FCO may decide the AP may move a lot longer than a location threshold based on the previous stored error ellipse and the last received error ellipse. The FCO may not use this previously stored error ellipse to request an AFC response from the FCC server. Thus, the AP may continue collecting GPS samples to determine a finer error ellipse, for example, using sixty or ninety GPS samples to determine the finer error ellipse. The AP may send the finer error ellipse to the FCO. The FCO may use this finer error ellipse to request an AFC response from the FCC server. The FCC server may approve the available channels and powers based on the finer error ellipse and may send the available channels and powers to the FCO. Then the AP may receive (via the FCO) some allowable channels and powers approved by the FCC server based on the finer error ellipse.

According to implementations of the present disclosure, an AP is capable of swiftly activating the 6 GHz frequency band following an upgrade and reboot of the AP. By transmitting the minimal necessary GPS data, the AP can efficiently receive the AFC response. The proposed solution is also suitable for situations where a new AP is being deployed. It can diminish the data amount of GPS reporting traffic exchanged among the AP, the FCO service, and the FCC server. Additionally, the proposed solution can conserve the processing resources of both the AP and the FCO service by reducing the load of GPS data.

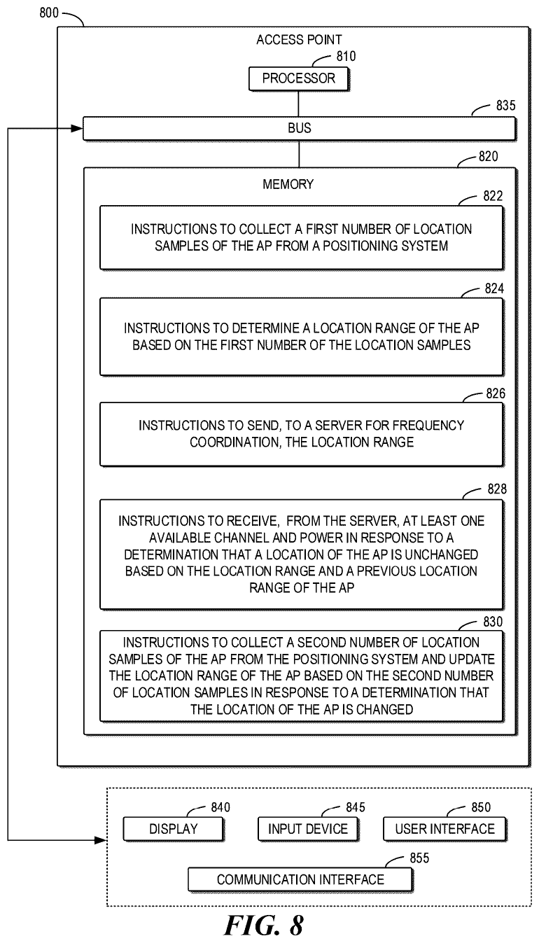

Reference is made to FIG. 8, which illustrates an example AP 800 according to implementations of the present disclosure. As shown in FIG. 8, the AP 800 comprises at least one processor 810, and a memory 820 coupled to the at least one processor 810. The memory 820 stores instructions 822, 824, 826, 828, and 830 to cause the processor 810 to perform actions according to example implementations of the present disclosure. As shown in FIG. 8, the memory 820 stores instructions 822 to collect a first number of location samples of the AP from a positioning system. The memory 820 further stores instructions 824 to determine a location range of the AP based on the first number of the location samples.

The memory 820 further stores instructions 826 to send the location range to a server for frequency coordination. The memory 820 further stores instructions 828 to receive at least one available channel and power from the server in response to a determination that a location of the AP is unchanged based on the location range and a previous location range of the AP. The memory 820 further stores instructions 830 to collect a second number of location samples of the AP from the positioning system and update the location range of the AP based on the second number of location samples in response to a determination that the location of the AP is changed based on the location range and the previous location range of the AP. The stored instructions and the functions that the instructions may perform can be understood with reference to the description of FIGS. 2-7. For the purpose of simplification, the details of instructions 822, 824, 826, 828, and 830 will not be discussed herein.

Similarly, by implementing the instructions 822, 824, 826, 828, and 830, the duration required to secure authorized channel and power assignments from the FCC can be shortened. This enhancement allows APs to broadcast over the 6 GHz frequency band in standard power mode at an accelerated pace.

The memory 820 may include a main memory, such as a random access memory (RAM), cache, and/or other dynamic storage devices, coupled to bus 835 for storing information and instructions to be executed by processor 810. The main memory also may be used for storing temporary variables or other intermediate information during the execution of instructions to be executed by processor 810. The memory 820 further may include a read-only memory (ROM) or other static storage device coupled to bus 835 for storing static information and instructions for processor 810. A storage device, such as a magnetic disk, optical disk, or USB thumb drive (Flash drive), etc., is provided and coupled to bus 835 for storing information and instructions.

The AP 800 may be coupled via bus 835 to a display 840, such as a liquid crystal display (LCD) (or touch screen), for displaying information to a computer user. The AP 800 may be coupled via bus 835 to an input device 845, including alphanumeric and other keys, coupled to bus 835 for communicating information and command selections to processor 810. Another type of user input device is cursor control, such as a mouse, a trackball, or cursor direction keys for communicating direction information and command selections to processor 810 and for controlling cursor movement on the display 840. In some examples, the same direction information and command selections as cursor control may be implemented via receiving touches on a touch screen without a cursor.

The AP 800 may include a user interface module 850 to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The AP 800 also may include a communication interface 855 coupled to the bus 835. The communication interface 855 provides a two-way data communication coupling to one or more network links that are connected to one or more local networks. For example, a communication interface may be an integrated service digital network (ISDN) card, cable modem, satellite modem, or a modem to provide a data communication connection to a corresponding type of telephone line. As another example, the communication interface may be a local area network (LAN) card to provide a data communication connection to a compatible LAN (or WAN component to communicate with a WAN). Wireless links may also be implemented. In any such implementation, the communication interface 855 sends and receives electrical, electromagnetic, or optical indicators that carry digital data streams representing various types of information.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
collecting, by an access point (AP), a first number of location samples of the AP from a positioning system;
determining, by the AP, a location range of the AP based on the first number of the location samples;
sending, by the AP and to a server for frequency coordination, the location range;
in response to a determination that a location of the AP is unchanged based on the location range and a previous location range of the AP, receiving, by the AP and from the server, at least one available channel and power; and
in response to a determination that the location of the AP is changed based on the location range and the previous location range of the AP, collecting, by the AP, a second number of location samples of the AP from the positioning system, and updating, by the AP, the location range of the AP based on the second number of location samples.

2. The method of claim 1, wherein at least one of the following:
the positioning system comprises a global positioning system (GPS);
the location samples comprise GPS samples; or
the server for frequency coordination comprises a federal communications commission (FCC) server.

3. The method of claim 2, wherein collecting, by the AP, the first number of location samples of the AP from the positioning system comprises:
collecting, by the AP, a predetermined minimum number of GPS samples from the GPS as the first number of location samples.

4. The method of claim 2, wherein determining, by the AP, the location range of the AP based on the first number of the location samples:
determining, by the AP, a first portion of the GPS samples and a second portion of the GPS samples from the minimum number of GPS samples based on a predetermined ratio;
determining, by the AP, an error ellipse based on the first portion and the second portion, wherein the first portion is inside the error ellipse and the second portion is outside the error ellipse; and
determining, by the AP, the error ellipse as the location range of the AP.

5. The method of claim 2, wherein sending, by the AP and to the server for frequency coordination, the location range comprises:
sending, by the AP, the location range to a frequency coordination orchestrator (FCO) associated with the AP, wherein the FCO is an individual cloud service exterior to the AP or included in the AP.

6. The method of claim 5, wherein receiving, by the AP and from the server, the at least one available channel and power comprises:
receiving, by the AP, the at least one available channel and power forwarded from the FCO, wherein the at least one available channel and power is received by the FCO from the FCC server.

7. The method of claim 1, wherein the AP determines whether the location of the AP is changed by:
determining, by the AP, a current location of the AP based on the location range of the AP;
determining, by the AP, a previous location of the AP based on the previous location range of the AP;
determining, by the AP, a distance between the current location of the AP and the previous location of the AP;
in response to a determination that the distance being smaller than a predetermined location threshold, determining, by the AP, the location of the AP is unchanged; and
in response to a determination that the distance being greater than the predetermined location threshold, determining, by the AP, the location of the AP is changed.

8. The method of claim 1, further comprising:
in response to the AP failing to receive the AFC response, sending, by the AP to the server, the location range every time the AP collects a maximum number of location samples.

9. The method of claim 1, further comprising:
in response to the AP failing to retrieve the previous location range of the AP, determining, by the AP, the location range of the AP based on a maximum number of the location samples; and
wherein sending, by the AP and to the server for frequency coordination, the location range comprises:
sending, by the AP to the server, the location range determined based on the maximum number of the location samples.

10. The method of claim 1, wherein the AP configures a plurality of parameters comprising at least one of the following:
a minimum number of location samples;
a maximum number of location samples;
retry times if the AP does not receive any AFC response; or
a rate for collecting location samples.

11. An access point (AP) comprising:
at least one processor; and
a memory coupled to the at least one processor, the memory storing instructions to cause the at least one processor to:
collect a first number of location samples of the AP from a positioning system;
determine a location range of the AP based on the first number of the location samples;
send the location range to a server for frequency coordination;
receive, from the server, at least one available channel and power in response to a determination that a location of the AP is unchanged based on the location range and a previous location range of the AP; and
collect a second number of location samples of the AP from the positioning system and update the location range of the AP based on the second number of location samples in response to a determination that the location of the AP is changed based on the location range and the previous location range of the AP.

12. The AP of claim 11, wherein at least one of the following:
the positioning system comprises a global positioning system (GPS);
the location samples comprise GPS samples; or
the server for frequency coordination comprises a federal communications commission (FCC) server.

13. The AP of claim 12, wherein the instructions to collect the first number of location samples of the AP from the positioning system comprise instructions to cause the at least one processor to:
collect a predetermined minimum number of GPS samples from the GPS as the first number of location samples.

14. The AP of claim 12, wherein the instructions to determine the location range of the AP based on the first number of the location samples comprises instructions to cause the at least one processor to:
determine a first portion of the GPS samples and a second portion of the GPS samples from the minimum number of GPS samples based on a predetermined ratio;
determine an error ellipse based on the first portion and the second portion, wherein the first portion is inside the error ellipse and the second portion is outside the error ellipse; and
determine the error ellipse as the location range of the AP.

15. The AP of claim 12, wherein the instructions to send the location range to the server for frequency coordination comprise instructions to cause the at least one processor to:
send the location range to a frequency coordination orchestrator (FCO) associated with the AP, wherein the FCO is an individual cloud service exterior to the AP or included in the AP.

16. The AP of claim 15, wherein the instructions to receive, from the server, the at least one available channel and power comprise instructions to cause the at least one processor to:
receive the at least one available channel and power forwarded from the FCO, wherein the at least one available channel and power is received by the FCO from the FCC server.

17. The AP of claim 11, wherein to determine whether the location of the AP is changed, the instructions further comprise instructions to cause the at least one processor to:
determine a current location of the AP based on the location range of the AP;
determine a previous location of the AP based on the previous location range of the AP;
determine a distance between the current location of the AP and the previous location of the AP;
determine the location of the AP is unchanged in response to a determination that the distance being smaller than a predetermined location threshold; and
determine the location of the AP is changed in response to a determination that the distance being greater than the predetermined location threshold.

18. The AP of claim 11, wherein the instructions further comprise instructions to cause the at least one processor to:
send, to the server, the location range every time the AP collects a maximum number of location samples in response to the AP failing to receive the AFC response; and
determine the location range of the AP based on a maximum number of the location samples in response to the AP failing to retrieve the previous location range of the AP, and wherein the instructions to send the location range to the server for frequency coordination further comprise instructions to cause the at least one processor to:
send, to the server, the location range determined based on the maximum number of the location samples.

19. The AP of claim 11, wherein the instructions further comprise instructions to cause the at least one processor to:
configure a minimum number of location samples;
configure a maximum number of location samples;
configure retry times if the AP does not receive any AFC response; or
configure a rate for collecting location samples.

20. A non-transitory computer-readable medium comprising instructions stored thereon which, when executed by an access point (AP), cause the AP to:
collect a first number of location samples of the AP from a positioning system;
determine a location range of the AP based on the first number of the location samples;
send the location range to a server for frequency coordination;
receive, from the server, at least one available channel and power in response to a determination that a location of the AP is unchanged based on the location range and a previous location range of the AP; and
collect a second number of location samples of the AP from the positioning system and update the location range of the AP based on the second number of location samples in response to a determination that the location of the AP is changed based on the location range and the previous location range of the AP.
